(19) United States
(12) Patent Application Publication
(10) Pub. No.: US 2015/0182082 A1
(43) Pub. Date: Jul. 2, 2015

(54) EFFICIENCY BLOWER

(71) Applicant: James Garcia-Otero, Colonial Heights, VA (US)

(72) Inventor: James Garcia-Otero, Colonial Heights, VA (US)

(21) Appl. No.: 14/143,256

(22) Filed: Dec. 30, 2013

(51) Int. Cl. A47L 5/14; B01D 46/24

(52) U.S. Cl. CPC A47L 5/14; B01D 46/2403

(57) ABSTRACT

The application discloses a truncated cone filter comprising a mesh material, an upper hole with a diameter slightly larger than a power transfer pipe, and a lower hole slightly larger than a diameter of a duct. In one embodiment, the duct is modified by drilling holes into a duct side surface to provide supplemental area for supplemental inlet air flow.

### RELATED APPLICATIONS

This application has no related applications, and is not funded by any government.

### FIELD OF THE DISCLOSURE

This application is directed to a high efficiency blower. Specifically, the efficiency of a leaf blower may be greatly increased by: using a specially shaped filter (with an upper hole, a lower hole, and a nearly vertical side) to prevent leaves from blocking the air inlet, by adding supplemental air inlet holes in the sides of the duct to facilitate supplemental air flow, by adding additional supplemental air inlet holes in the bottom surface of the base to facilitate additional supplemental air flow, and/or by making the top surface of the duct substantially flat or sloped outwardly.

### BACKGROUND

Leaf blowers use air to blow leaves or other light debris in a desired direction. This eliminates the need for raking leaves, and thus reduces labor.

Leaves often block the flow of inlet air into the blower. Specifically, leaves are blown by the inlet air flow into the upper surface of the duct. These leaves are held on the upper surface of the duct by the air flow, and these leaves partially block the air flow. If the duct upper surface is horizontal, then gravity also helps to hold the leaves against the upper surface of the duct. Further, some ducts have a lip around the circumference of the duct, and the lip makes it difficult to remove the leaves by merely physically brushing them sideways.

Additionally, many leaf blowers suffer from a very small air inlet area (even before being blocked by leaves). This small air inlet area reduces the amount of air being blown, and reduces the exit velocity of the air being blown.

Thus, there is a need for preventing leaves from blocking the inlet air flow, and there is a need for increasing the air inlet area.

Conventional leaf blowers may or may not have an integral power supply. Some detachable power supplies are configured to attach and detach from various tools: blowers, edgers, saws, weed whips, etc. The non-limiting illustrative blower discussed in this application is a Ryobi™ blower attachment.

FIG. 1 illustrates conventional leaf blower 100, power supply 190, and user 198 wearing silly hat 199. The user's name may be Heisenberg.

Blower 100 has three major components comprising: pipe 110, duct 120, and base 130. Pipe 110 may include vertical straight section 112, upper curved section 114, top pipe end 116, and pipe bump 118.

Duct 120 may include duct upper surface 122 and duct side surface 124. Pipe 110 is attached to (or integral with) duct upper surface 122.

Base 130 may include base upper surface 134, base side surface 136, base lower surface 138, and base air outlet 132. Duct 120 is attached to (or integral with) base upper surface 134.

Power supply 190 may include: power end 196 configured to receive pipe end 116, power bump receiver 193 configured to receive pipe bump 118, power shaft 192, and power engine 194.

User 198 may wear silly hat 199, may be named Heisenberg, and may ask, “What's my name?” every time that he blows leaves. The user's silly hat, name, and question are not essential to the disclosed invention.

FIG. 2 illustrates duct upper surface 122, located above base upper surface 134. Duct upper surface 122 may include the upper surface of grid 122A, structural triangle 122B (including a cross section of pipe 110), and lip 122C. Open area 123 allows air to enter blower 100. Pipe 110 and duct upper surface 122 block air flow into duct 120. A cross sectional area of duct 120 includes the following areas or surfaces: grid 122A, structural triangle 122B (including a cross section of pipe 110), and lip 122C, and open area 123. Pipe 110 may penetrate structural triangle 122B, but the entire structural triangle 122B (including a cross section of pipe 110) is considered an upper surface with respect to blocking inlet air flow.

Leaves L2, L3, L4 and L5 are blown downward against duct upper surface 122, and these few leaves may block some or most of open area 123, thus greatly reducing the available (or effective) open area and greatly reducing the flow of air through the blower. The flow of air forces these leaves against duct upper surface 122, and holds these leaves in place when the blower is blowing. Additionally, gravity holds these leaves in place even if the blower is turned off.

The inventor experimentally observed that Leaf L1 is small, and generally passes through the open area 123 and blows through the blower with few problems. Leaf L6 is very small, and is blown through open area 123 and blower 100 with almost no problems. Dimension D5 is discussed later. Conventionally no importance is attached to dimension D5.

Specifically, dimension D5 (in FIG. 2) is a characteristic dimension of openings in open area 123. This characteristic dimension D5 does not appear to be recognized in the prior art.

The bottom portion of FIG. 2 illustrates a side view of duct upper surface 122, including grid surface 122A, lip surface 122C and structural triangle surface 122B. Lip surface 122C and structural triangle surface 122B extend upwards beyond the upper surface of grid 122A, thus creating a recessed volume 122D (below structural triangle surface 122B and lip surface 122C) that tends to capture and hold leaves against grid 122A and within the perimeter of lip 121

Large leaves such as leaf L3 may extend horizontally beyond lip surface 122C, and thus may be grabbed by user 198 and physically removed after the blower is turned off. In contrast, medium sized leaf L2 is a huge problem. Leaf L2 is blown against grid 122A and held in recessed volume 122D. It is very difficult for user 198 to remove leaf L2, because leaf L2 is recessed. Further, if leaf L2 is flexible, then some edges of the leaf may be blown downward into blower 100, and leaf L2 halfway wrapped around a thin portion of grid surface 122A.

Duct diameter D2 is 3.75 inches, yielding a total area of about 11 sqin (square inches) for the cross section of the duct. Open area 123 covers about 50% of the total area (or about 5.5 square inches). Duct upper surface 122 (including a cross sectional area of pipe 110) combine to cover the remainder of the total area (about 5.5 square inches). In other words, the total area is about 50% open area 123 (allowing inlet air flow) and about 50% non-open area or duct upper surface 122.

FIG. 3 illustrates a side view of a blower 100, with dimensions. Pipe 110 has pipe diameter D1 (1 inch) and pipe height H1 (4.5 inch). Pipe height H1 is defined at the bottom of FIG. 3. Pipe 110 may start curving immediately as it exits duct 120. Thus, the height H1 of pipe 110 is defined herein as the height at which a deviation of ½ of pipe diameter D1 occurs for a curved pipe, or as the entire height of the pipe for a straight pipe. The bottom of height H1 begins at the top of lip 122C. If the top of structural triangle 122B is at the same level as the top of lip 122C, then the bottom of height H1 may be measured by beginning at the top of structural triangle 122B, for convenience.

Duct 120 has duct diameter D2 (3.75 inch) and duct height (0.875 inch, or ⅞ inch). Total cross sectional area of the duct is about 11 square inches (about 5.5 square inches of open area admitting inlet air, and about 5.5 square inches of surface area blocking inlet air).

Base 130 has base diameter D3 (9 inch to 11 inch) and base height H3 (2 inch). The base is usually not cylindrical, but is still usually approximately cylindrical. Base air outlet 132 may be a rectangle approximately 5 inches wide by 2 inches tall (totaling about 10 square inches of exit area). Thus, the exit area is about 10 sqin (square inches), whereas the open area is only about 5.5 sqin.

This blower is very unbalanced because the open area for inlet air flow is only about half of the exit area for outlet air flow.

It appears that the designers of this blower failed to consider the large decrease in open area caused by the relatively large area (5.5 sqin) of duct upper surface 122. If duct upper surface 122 is neglected, then the inlet area is about 11 sqin (cross sectional area of duct 120), which is roughly equivalent to the exit area of 10 sqin. Thus, the small inlet area 123 of this blower is causing a disproportionate amount of power loss (relative to the power loss caused by the exit area).

Thus, there is a need for preventing leaves from blocking the inlet air flow, and there is a need for providing a supplemental open area to increase the total inlet area into the duct, thereby increasing outlet air flow. Further, there is a need to raise the upper surface of the grid to eliminate the recess that catches and holds leaves.

### SUMMARY

FIGS. 1-3 described a conventional leaf blower illustrating a need for preventing leaves from blocking inlet air flow, and illustrating a need for providing a supplemental open area to increase the total inlet area for air flow.

In one embodiment, a truncated cone made of flexible mesh has an upper hole configured to accommodate a power transfer pipe, and has a lower hole with a lower hole diameter slightly greater than a diameter of a duct, such that the truncated cone can slide over the pipe and slide down into a snug contact with the duct.

In one embodiment, a flat and flexible mesh has a shape of a truncated cone that was slitted and flattened. This flat and flexible mesh may be shaped into a truncated cone by a user, and may be stapled into a truncated cone shape by the user. Flaps and/or marked target areas may assist the user in creating a truncated cone from the flat and flexible mesh.

In one embodiment, supplemental holes are drilled into a side of a duct to provide additional inlet area for supplemental inlet air flow, in order to compensate for a an open area on the top of a duct that is much smaller than an outlet area in a base.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a conventional leaf blower 100.

FIG. 2 illustrates a duct upper surface 122.

FIG. 3 illustrates a side view of a blower 100, with dimensions.

FIG. 4 illustrates filters.

FIG. 5 illustrates more filters.

FIG. 6 illustrates filter details for a truncated filter.

FIG. 7 illustrates a largest truncated cone.

FIG. 8 illustrates a large cone.

FIG. 9 illustrates a tall medium cone.

FIG. 10 illustrates a short medium cone.

FIG. 11 illustrates a short small cone.

FIG. 12 illustrates flat cone details.

FIG. 13 illustrates flap details.

FIG. 14 illustrates edge details.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

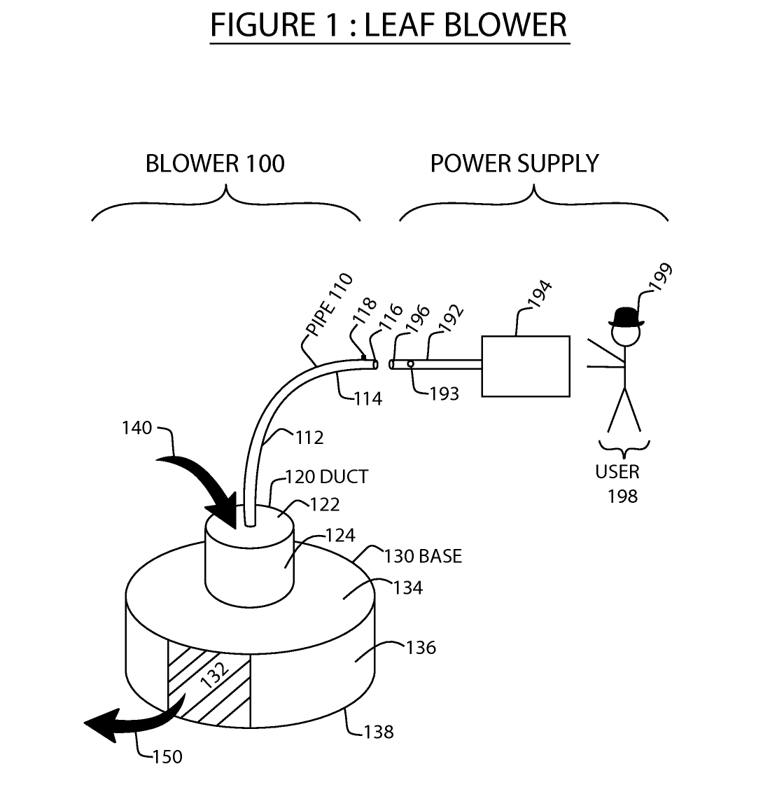

FIGS. 1-3 illustrate a conventional blower, and were discussed above in the background section.

Characteristic dimension D5 inherently exists in the conventional blower, but this characteristic dimension does not appear to be recognized by the prior art. Similarly, the unbalanced air inlet area and air outlet area inherently exist in the conventional blower, but this unbalance does not appear to be recognized by the prior art.

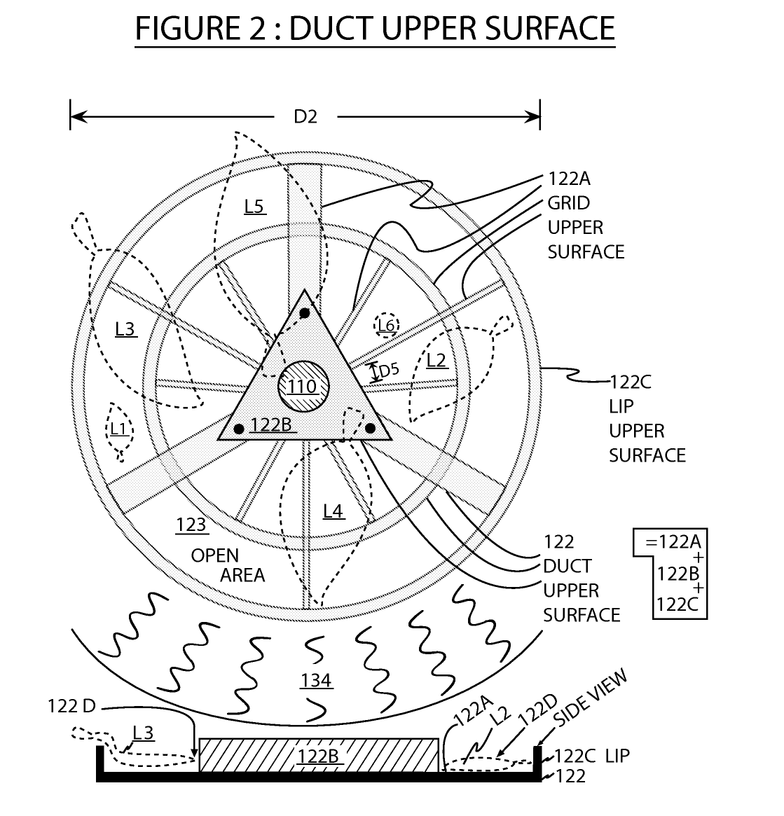

Specifically, characteristic dimension D5 (in FIG. 2) is a characteristic dimension of openings in open area 123. Characteristic dimension D5 is defined herein as the length of the largest leaf that may pass through the openings of the open area (while parallel to the surface of the open area). Thus, largest dimension of leaf L6 is smaller than characteristic dimension D5.

If the open area consisted only of equally sized circular holes, then characteristic dimension D5 is defined herein as the diameter of the holes. If the holes are not equally sized, then characteristic dimension D5 is defined herein as the average diameter of the holes. For a rectangular opening, characteristic dimension D5 is defined herein as the length of the smallest side.

Any filter configured to block leaves should have a characteristic dimension DF less than or equal to the characteristic dimension D5 of the openings in open area 123. In other words, DF should be equal to or less than 3/16 inch for any filter configured to block leaves. In this way, leaves will not pass the filter and then get blocked by the grid.

For a trapezoidal opening, D5 is defined herein as the length the smallest side of the trapezoidal opening. The characteristic dimension D5 of open area 123 of a conventional Ryobi blower 100 is about 3/16 inch (see FIG. 2). This application uses 3/16 inch for the purpose of exemplary calculations. Note the “trapezoidal” opening shown in FIG. 2 is not a perfect trapezoid because two opposite edges are not exactly straight, but a trapezoid is a very close polygonal approximation.

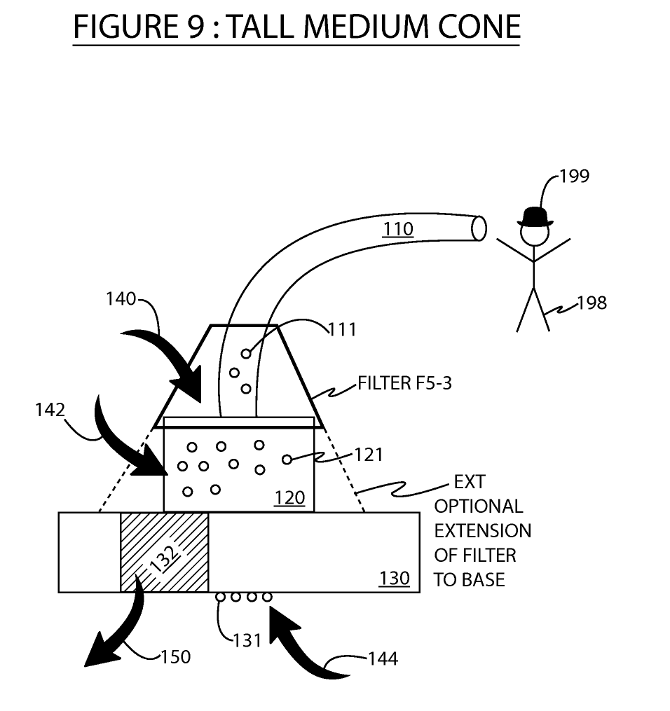

Balance BAL is defined herein as total inlet area divided by outlet area. In the above conventional example, balance equals open area 123 (5.5 sqin) divided by the open area of base air outlet 132 (10 sqin), or 55%. Ideally, balance B should be very close to 1 (90%≦BAL≦110%). Preferably, balance should be near 1 (75%≦BAL≦125%). Thus, in the above conventional example BAL=55%, and supplemental inlet area is desired. 20% of 10 sqin equals 2 sqin. Thus, a minimum supplemental inlet area of 2 sqin is desired to drive the total inlet area up to 7 sqin, and drive balance BAL up to 75%. A method to supplement the inlet area by 20% is discussed in detail with respect to in FIG. 9 below.

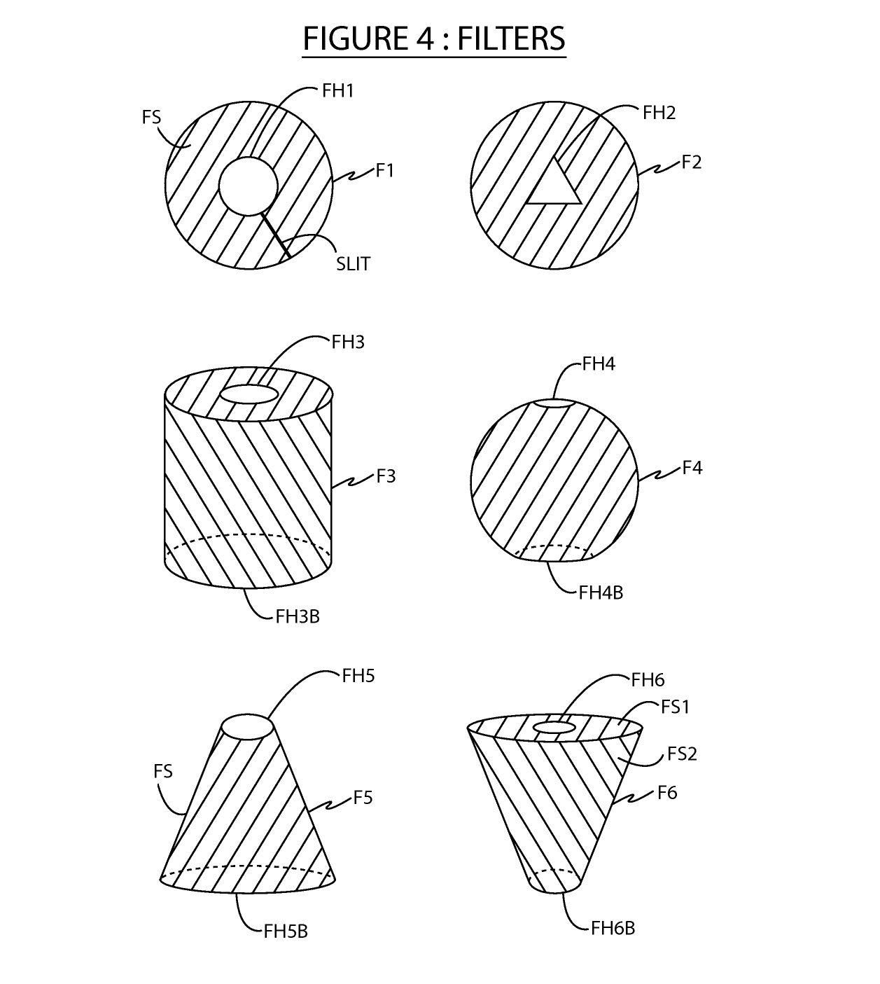

FIG. 4 illustrates novel filters. Filter F1 includes washer shaped surface FS with a central hole FH1 to accommodate pipe 110, and is the simplest configuration. Filter F1 may have a radial slit (not shown) to facilitate placing filter F1 into position (adjacent to duct upper surface 122) without necessarily removing optional power supply 190. All filters may have optional slits for this purpose. Surface FS may be a mesh such as mosquito netting, or a “pet guard” mesh.

Filter F2 includes is washer shaped surface like filter F1, but with a triangular central hole FH2 to accommodate structural triangle 122B.

Filter F3 is cylindrical, but with a hole FH3 on top to accommodate pipe 110, and with no bottom surface such that bottom hole FH3B accommodates duct 120. The sides of filter F3 are vertical, facilitating gravity pulling leaves down from the sides of filter F3. However, the top surface of filter F3 is horizontal, and gravity will hold leaves against this horizontal surface.

Filter F4 is smooth and approximately spherical, with upper hole FH4 to accommodate pipe 110 and lower hole FH4B to accommodate duct 120. The smooth surfaces of filter F4 facilitate gravity pulling leaves from the sides.

Filter F5 includes a truncated cone shaped surface FS, upper hole FH5 to accommodate pipe 110, and lower hole FH4B to accommodate duct 120. By experimentation, this truncated cone configuration resulted in excellent performance. The truncated cone may be a perpendicular (or “regular”) truncated cone (shown) or may be an oblique truncated cone (not shown).

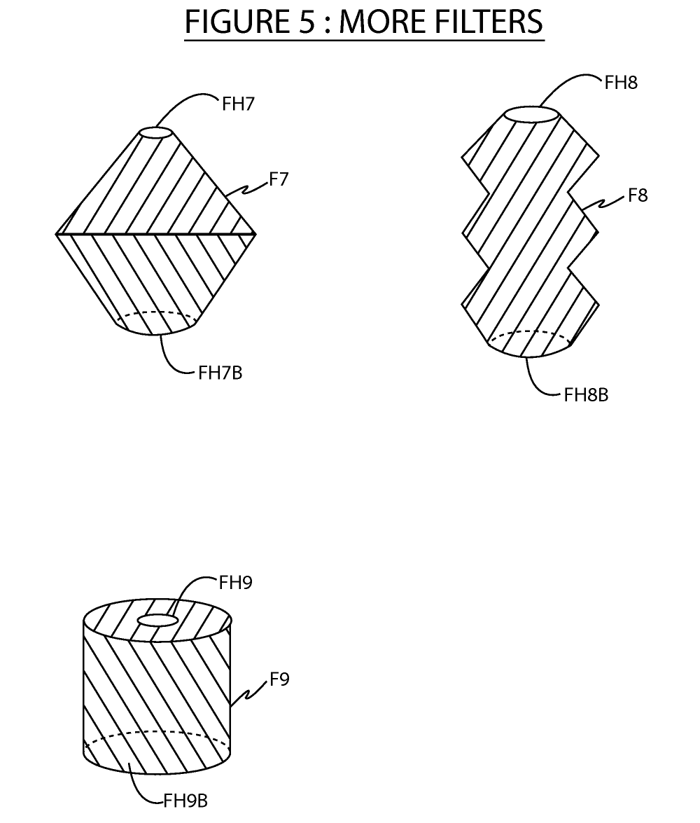

In an oblique truncated cone, the upper hole F5 is horizontally offset. This horizontal offset may be configured to match the slight curvature of the lower and relatively straight portion of pipe 110 (pipe straight section 112). However, experimentation with relatively flexible materials combined with the relatively small curvature of pipe 110 indicate that the complications of designing an oblique cone (and of properly orienting the oblique cone to match the curvature of pipe 110) may outweigh any slight advantage caused by obliqueness. Additionally, an oblique truncated cone is not pleasing to the eye. However, in the case where the pipe curvature is great and/or the filter materials are very rigid, then an oblique truncated cone may be preferred. Other filters shown in FIGS. 4 and 5 may also have offset upper holes and/or oblique shapes.

Filter F6 includes inverted truncated cone surface FS2, washer shaped upper surface FS1, upper hole FH6 to accommodate pipe 110, and lower hole FH6B to accommodate duct 120.

FIG. 5 illustrates more novel filters. Filter F7 illustrates an upper truncated cone (with opening FH7) joined to a lower inverted truncated cone (with lower opening FH7B). Filter F8 illustrates an accordion shaped filter with upper hole FH8 and lower hole FH8B. This accordion shape has the advantage of having a very large surface area, and of being adjustable in height by expanding or contracting the accordion. Filter F9 is a large cylinder similar to Figure F8 and including an upper hole FH9, but having a large diameter so that lower hole FH9B is sized to accommodate base 130.

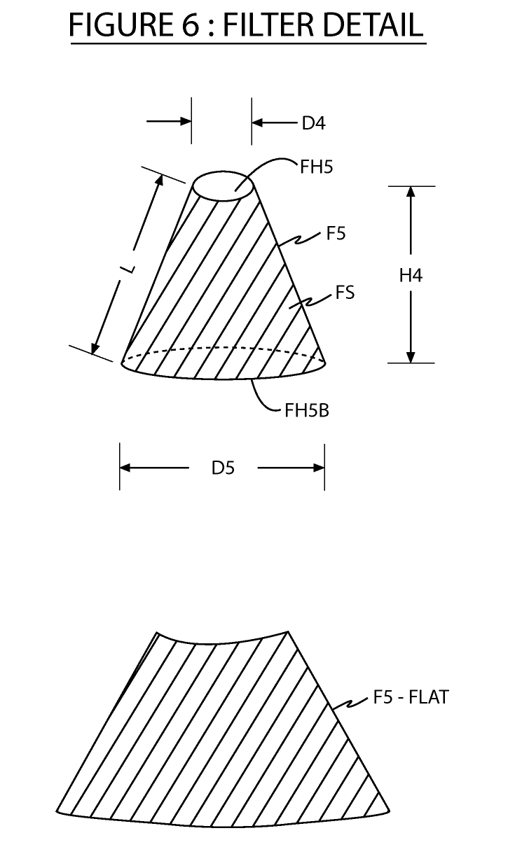

FIG. 6 illustrates filter details for a truncated cone filter F5. Filter F5 may include surface (or side) FS, upper hole FH5 with diameter D4 sized to accommodate pipe 110 (slightly greater than pipe diameter D1 which is 1 inch and optionally sized to also accommodate slipping over pipe bump 118 while sliding down pipe 110), and lower hole FH5B. A flexible filter materiel or a slightly loose fit (D4>D1) may accommodate pipe bump 118.

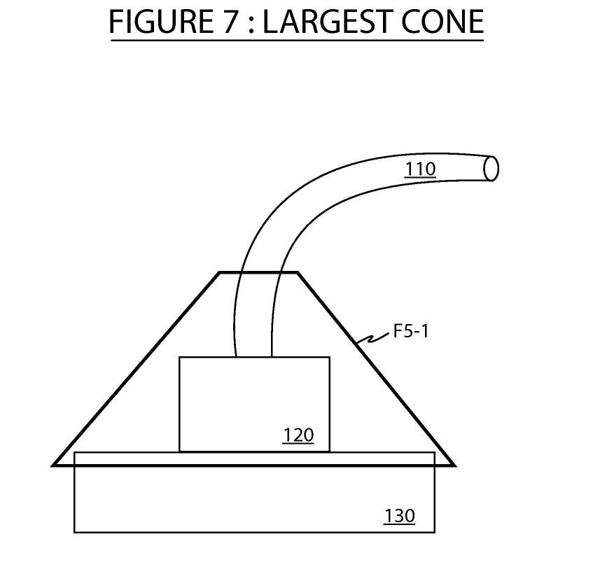

F5 may be slit and flattened into F5-FLAT, shown in the bottom of FIG. 6. Similarly (or inversely), F5-FLAT may be shaped and the edges joined to form three dimensional truncated cone filter F5 at the top of FIG. 6. FIGS. 7-11 illustrate various truncated cone filters fitted on blower 100.

FIG. 7 illustrates largest truncated cone F5-1, sized to fit snuggly onto base 130. In other words, bottom diameter D5 of hole FH5B is slightly greater than base diameter D3. If the base is not exactly a cylinder, then a perimeter of bottom hole FH5B is slightly greater than a perimeter of base 130.

The term “slightly greater” is defined with respect to truncated cones being fitted onto ducts or bases as follows. A bottom diameter D5 of a filter is “slightly greater” than a base diameter D3 when the bottom of the filter rests between ¼ inch and 2 inches below base upper surface 134 after the filter is firmly pushed down onto the base. If the filter is flexible, then the filter becomes snug against the base after being pushed down onto the base.

A bottom diameter D5 of a filter is slightly greater than a duct diameter D2 when the bottom of the filter rests between ¼ inch and 2 inches below duct upper surface 134 after the filter is firmly pushed down onto the duct. If the filter is flexible, then the filter becomes snug against the duct after being pushed down onto the duct.

The height of H4 may be 80% to 120% of pipe height H1 to create a very large truncated cone with a very large surface area, thus causing a very low air velocity as air is drawn through the filter and towards duct 120.

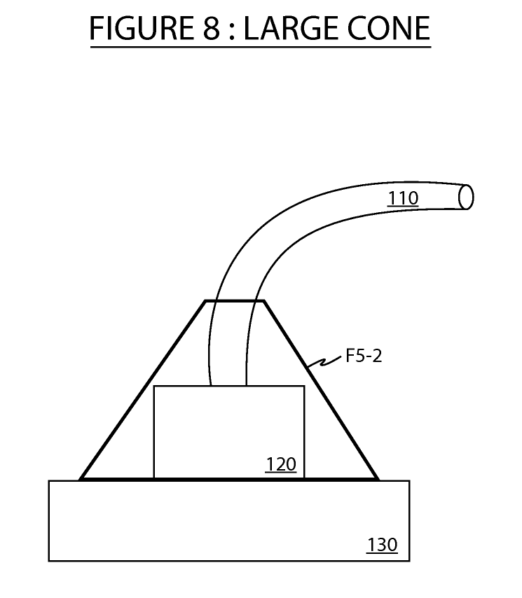

FIG. 8 illustrates large truncated cone filter F5-2, which is similar to cone F51, except having a lower hole diameter D5 less than base diameter D3 and greater than duct diameter D2. The bottom of filter F-5 rests on base upper surface 134, and may be attached to base upper surface 134. Filter F-5 is sized so that duct 120 is not touched. Large cone F5-2 may be preferred if large openings are placed into the side of duct 120 to increase inlet area by supplementing open area 123.

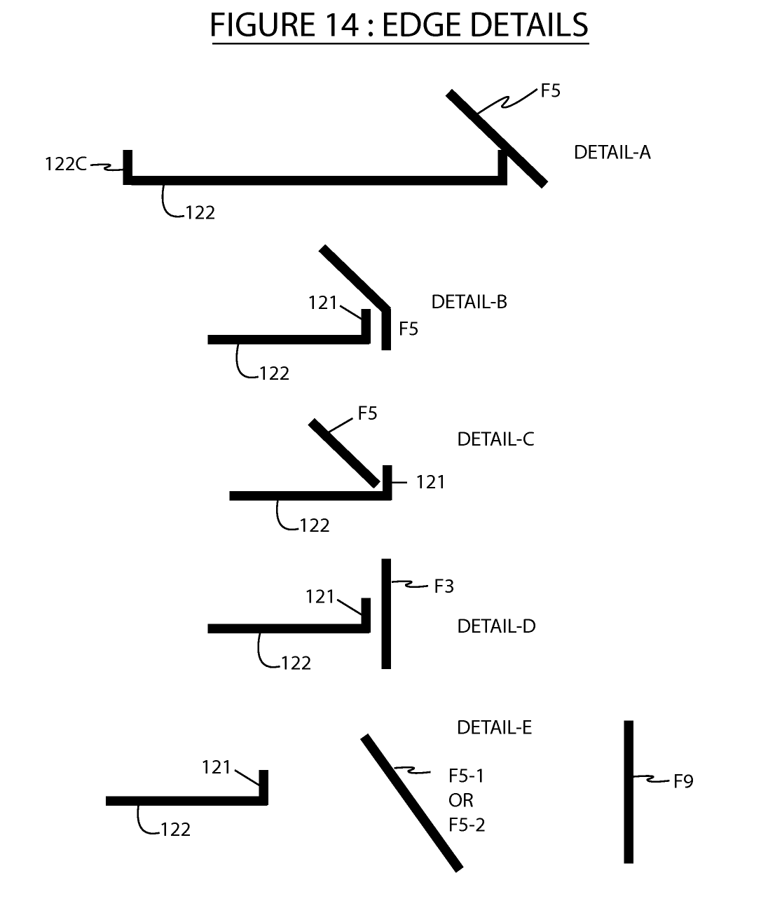

FIG. 9 illustrates tall medium truncated cone filter F5-3. Filter F5-3 includes an upper hole FH5 with diameter D4 (see FIG. 6) sized to accommodate pipe 110. The lower hole FH5B with diameter D5 is sized to fit snugly onto duct 120, as shown (D5 is slightly greater than duct diameter D2. Filter F5-3 may extend between 0.25 inch and 1 inch down onto duct 120. See FIG. 14 for edge fitting details.

Height H4 of filter F5-3 is preferably large and approximately equal to pipe height H1 (about 80% to 110% of pipe height H1). A large height H4 has several advantages over a smaller height: the angle of the side of the filter is close to vertical (so that gravity helps to remove leaves), and the area of the filter is greater (so that air flows into the filter over a greater area, and thus the air flows with a lower velocity and does not push the leaves hard onto to filter).

Experiments indicate that merely temporarily reducing blower speed (the user taking his finger off of the trigger) causes leaves to automatically fall from the filter by the force of gravity (without requiring a user to physically brush the leaves away). This is a wonderful experimental result.

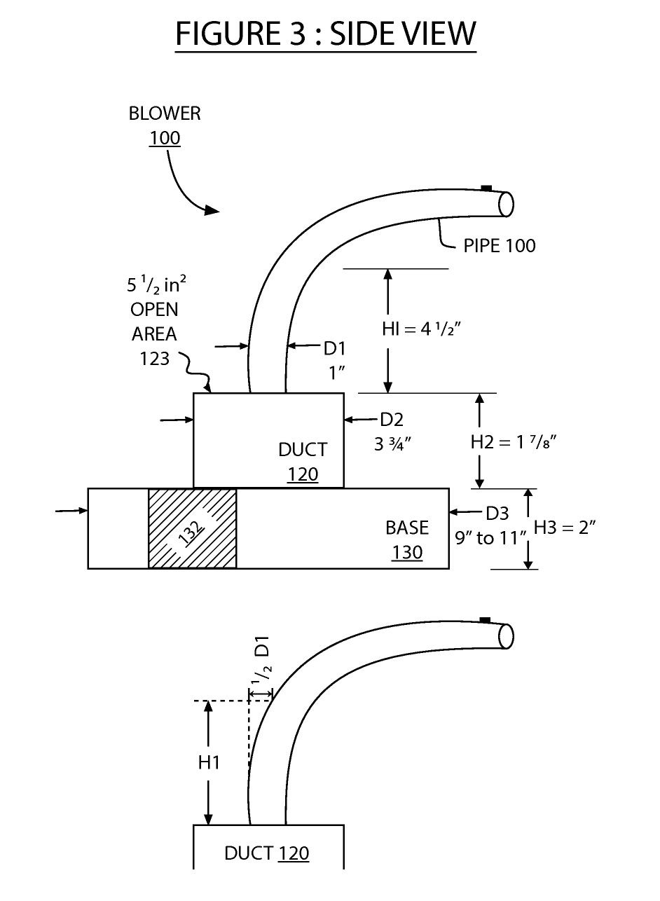

In order to increase inlet area, holes 121 may be drilled into base side surface 136. Referring to the above discussion regarding dimensions of FIGS. 2 and 3, a supplemental inlet area of at least 2 sqin is desired to bring the total inlet area up to 7.5 sqin (75% of the 10 sqin outlet area of base air outlet 132. This supplemental inlet area may be created by one or more of at least four different ways.

First, holes 121 may be drilled or otherwise manufactured into duct side surface 124. If the holes are 3/16 inch diameter, then about 72 holes are required. If rectangular slots ( 3/16 inch by 1 inch) are used, then about 14 are needed. These slots may be oriented such that the long side is vertical. If these slots are increased to 3/16 inch by 1.25 inch, then only 10 are needed to create 2 sqin of supplemental inlet area. If ¼ inch diameter holes are used, then only about 41 holes are needed. Holes 121 facilitate supplemental air flow 142.

If holes 121 are used, then filter F53 may be extended downwards to contact base upper surface 134, even while optionally maintaining a snug fit against the outside upper edge of duct upper surface 122. Alternatively, if holes 121 or rectangular slots are relatively small ( 3/16 diameter), then most leaves will be “screened,” and the vertical surface of duct side surface 124 facilitates gravity pulling screened leaves downward and away from the sides.

Also, if holes 121 are used, then largest filter F5-1 may be useful, because gravity will pull all leaves down along the sides of the filter all the way down to below base upper surface 134, and then down directly to the ground. Again, base 130 may not be cylindrical, so the largest filter F5-1 might not appear symmetric. Large filter F5-2 might be preferred.

Second, holes 111 may be placed into pipe 110 so that the interior of pipe 110 (that is not occupied by a power transfer cable or shaft or similar) may pass inlet air downward into the center of duct 120. These holes 111 may transfer dirt into the power transfer cable and related bearings, so this is not preferred for a conventional leaf blower.

Third, holes 131 may be drilled into the base lower surface 138. Preferably holes 131 are located below duct 120, so that supplemental inlet air 144 moves into the center of base 130, and is pushed by a fan outwards through base air outlet 132. Interestingly, in some blowers an internal fan assembly includes an internal bottom surface (not shown) that prevents air from upwardly entering the central area inside of the fan from the bottom. Additional holes (not shown) may be drilled into this bottom surface of the internal fan to allow supplemental inlet air 144 to enter the central area inside of the fan.

Fourth, merely drilling holes 131 may allow inlet air 144 to get drafted below the fan (bypassing the fan) and get drafted into outlet airflow 150. The third and fourth methods may occur simultaneously.

Holes 131 may be drilled between concentric circular bumpers (not shown) that extend downward slightly below a center of base lower surface 138 (below duct 120). These bumpers keep base lower surface 138 slightly above the ground, and may facilitate air flow 144 by preventing relatively flat base lower surface 138 from vacuum sealing against the ground.

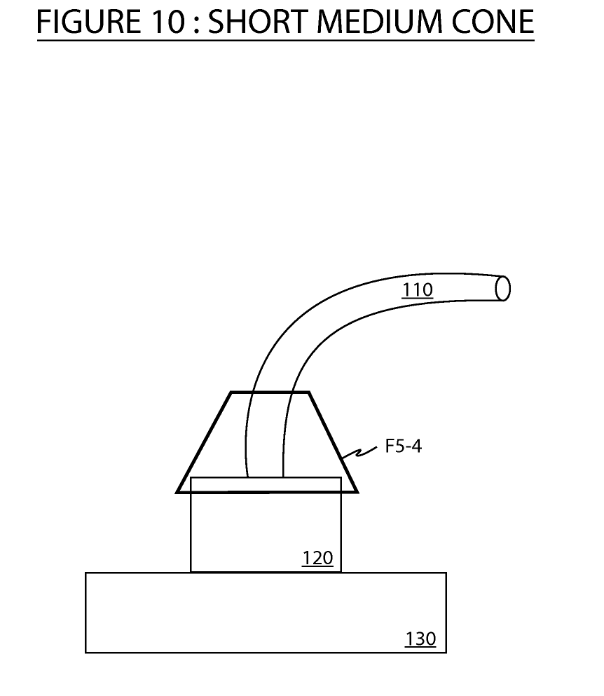

FIG. 10 illustrates a short medium truncated cone filter F-4. This filter F-4 is cheap and light, and may fit snuggly onto duct 120.

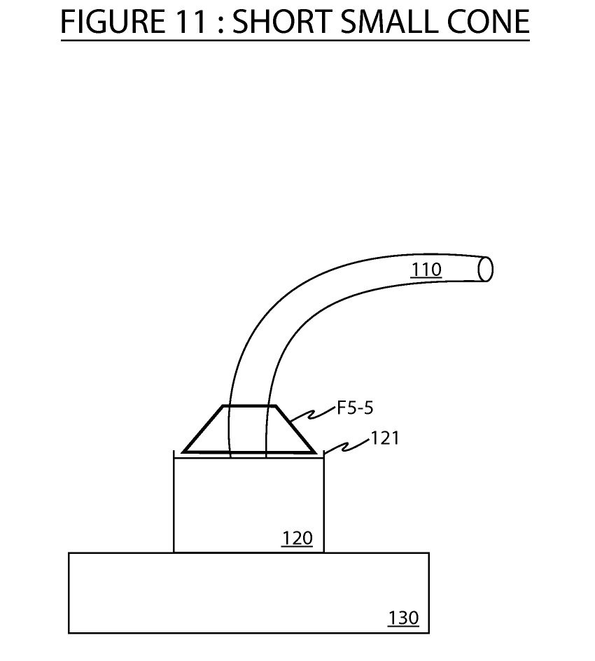

FIG. 11 illustrates a short small cone with a bottom hole diameter D5 sized to fit slightly inside of rim 121 of duct 120.

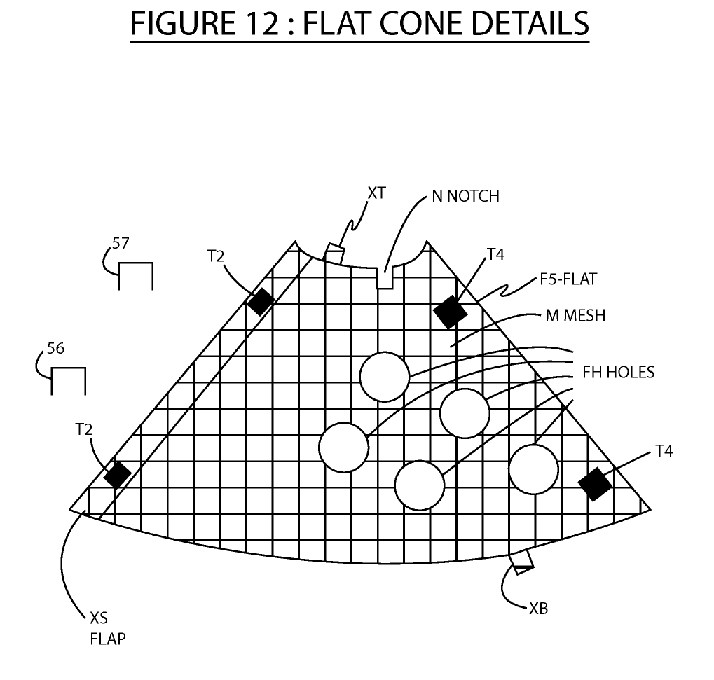

FIG. 12 illustrates a flat cone details. Geometrically, flat cone F5-FLAT is a truncated cone that has been slit and flattened. This flat cone F5-FLAT may be used to construct a truncated cone. This flat cone may be shipped and sold flat, for later construction by a user.

Many technical details are illustrated in FIG. 12. Flat cone F5-FLAT may be manufactured from a material such as mosquito netting M having a mesh structure. The material may be flexible plastic or metal and may have holes of approximately ⅛ inch to ¼ inch diameter. The mesh material may have additional holes of approximately ⅛ to ¼ inch diameter formed or punched into the mesh, such that the mesh provides structure (and some open area through small holes), but large amounts of open area may also be supplied by the approximately ⅛ to ¼ inch diameter holes.

Side flap XS may be used to overlap flat cone F5-FLAT to make a truncated cone F5, targets T2 on flap XS may be positioned over targets T4, and then staples S6 and S7 may be used to staple targets T2 onto corresponding targets T4. Targets may be marked on flat cone F5-FLAT to help a user position the flap before stapling. Velcro or tape may be used with flap XS to help construct truncated cone F5.

Lower flap XB may be attached to duct 120 or base 130 adhesively (glue or tape or Velcro) or mechanically (e.g., by a screw). Upper flap XT may be attached to pipe 110 adhesively, mechanically, by hose clamp, or by cable tie.

Filter F5-FLAT may be cut from a mosquito screen mesh, or from a pet guard screen (that is mosquito resistant). The pet guard screens are similar to mosquito screens, but are thicker and stronger to block pets. Experimentally, the inventor learned that a commercial pet guard screen had a convenient combination of flexibility and rigidity, and had

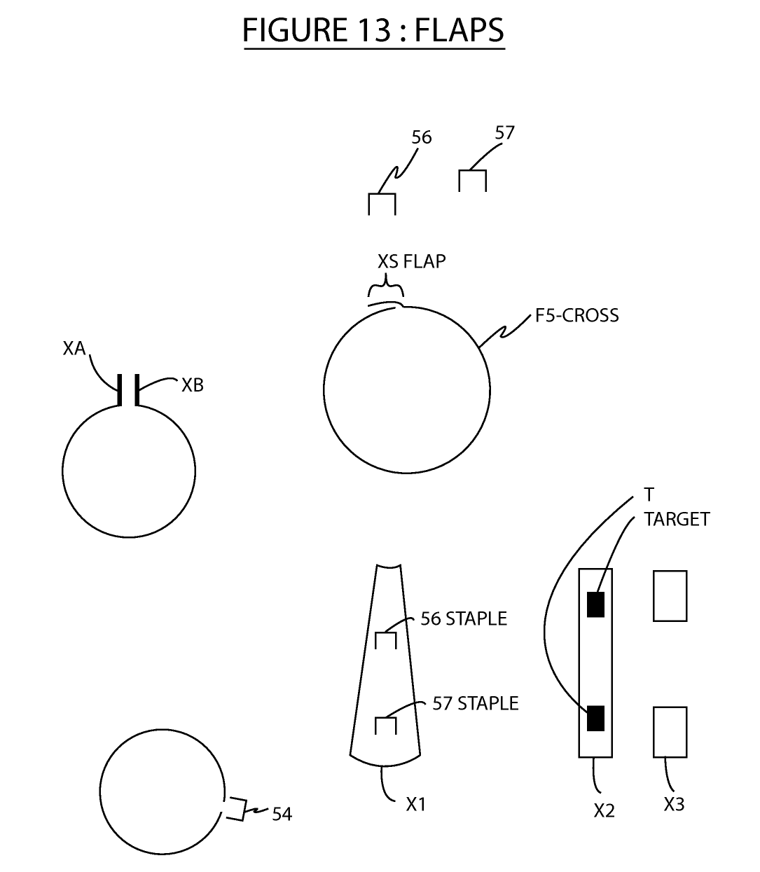

The overlap of side flap XS shown in FIG. 13 increases the rigidity of a portion of truncated cone F5, which may be useful, depending upon the material that is used.

FIG. 13 illustrates flaps and methods of connecting edges. Side flap XS overlaps a portion of (formerly) flat cone F5-flat, as shown in cross section F5-CROSS, and may be stapled into place by staple S6 and/or staple S7. Side flap X1 may be shaped as shown, so that it perfectly matches the top edge and bottom edge of the portion of the cone that it overlaps. Alternatively, flap X2 may be relatively small, or flaps X2 may be very small (e.g., just big enough for a staple).

Two side flaps XA and XB may be joined together and may create a ridge extending perpendicular to the surface of filter F5, as shown in FIG. 13.

Alternatively, no flaps are necessary. The straight edges of truncated cone F5-FLAT may be joined adjacently as shown at the bottom left of FIG. 13 by one or more staples. Targets may be provided to help a user.

Experimentally, this “no flap, no overlap” stapling method performed surprisingly well, especially if three or more staples were used to link the edges. Other methods such as wire ties or tape may be used to join the straight edges (or secure a flap) to form a truncated cone.

Interestingly, a standard stapler does not quite enter D4 (D4 is slightly greater than pipe diameter D1, or slightly greater than 1 inch) if filter F5 is already created. However, due to the flexible nature of the pet guard material, a staple may easily be placed one inch or two inches away from the top edge of filter F5 because the top portion of the truncated cone easily flexes apart (at the unconnected slit or seam) to accommodate a standard stapler. This procedure also facilitates the filter sliding over pipe bump 118, and facilitates a snug fit wherein diameter D4 may be slightly less than D1, because an unstapled slit is maintained at the top inch of filter F5 and the top portion of filter F5 may be slightly deformed outwardly

Two or three targets located near one straight edge of flattened cone F5-FLAT may be aligned with a corresponding two or three targets near the other straight edge, and these corresponding may be stapled (without overlap) together by a user. A minimum of two staples is required, but three or four staples (stapling three or four pairs of targets) is preferred.

FIG. 14 illustrates edge details. Lip 121 with lip upper surface 122C extends upwardly as part of duct upper surface 122, as previously discussed in FIG. 2. DETAIL-A illustrates that truncated cone filter F5 may just slightly contact lip 121. Filters F5-3, F5-4, and F5-5 (with extension EXT) may also fit this way.

DETAIL-B illustrates that truncated cone filter F5 may snuggly conform to the outside of lip 121. Filter F5-3 and F5-5 (with extension EXT) may also fit this way.

DETAIL-C illustrates that truncated cone filter F5 may fit just inside of lip 121.

DETAIL-D illustrates that cylindrical filter F3 may pass vertically adjacent to or vertically just touching the outside of lip 121.

DETAIL-E illustrates that truncated cone filters F51 or F5-2 or cylindrical filter F3 may pass substantially away from the outside of lip 122C.

Those skilled in the art will recognize improvements and modifications to the preferred embodiments of the present disclosure.

For example, blower 100 may blow materials other than leaves. The blower may be oriented in different directions, so that blower 100 may be rotated 90 degrees or even 180 degrees from the orientation shown in FIG. 1. In the case of a rotated orientation, it may be necessary to adhesively or mechanically secure the filter into place.

Further some “backpack” style leaf blowers do not have a pipe extending outward from the open area that admits inlet air flow. These “backpack” style blowers do not require a hole to accommodate a pipe. Many of the above concepts still apply to a “backpack” style blower. For example, an external filter (perhaps flat, or simple untruncated cone, or dome shaped) may still prevent leaves from getting caught in recesses. Further, additional holes or slots may be required to provide supplemental inlet area to raise the total inlet area to at least 75% of the outlet area.

The recessed grid surface 122A may be raised to the same level as lip upper surface 122C and structural triangle upper surface 122B, thus eliminating the problematic recess 122D shown FIG. 2. Even better, these upper surfaces may be shaped into approximately a truncated cone or a dome so that gravity will assist in removing leaves from the surfaces.

Those skilled in the art will recognize additional improvements and modifications to the preferred embodiments of the present disclosure. All such improvements and modifications are considered within the scope of the concepts disclosed herein and the claims that follow.

What is claimed is:

1. A filter for increasing an efficiency of a blower, wherein the blower includes a pipe, a duct, and a base, the filter comprising:
a filter upper hole having an upper hole diameter and configured to accommodate a diameter of the pipe;
a filter surface with openings configured to pass inlet air and to block undesired objects; and
a filter lower hole having a lower hole diameter

2. The filter of claim 1, wherein the filter surface comprises a mesh material having mesh openings.

3. The filter of claim 1, wherein the filter surface comprises a mesh structure defining regularly spaced small openings of less than ⅛ inch diameter or width.

4. The filter of claim 3, wherein the mesh material further includes at least 20 additional holes, each additional hole with a diameter of at least 3/16 inch.

5. The filter of claim 1, wherein the filter lower hole diameter has a lower hole perimeter that is slightly greater than a perimeter of the base.

6. The filter of claim 1, wherein the filter lower hole diameter is slightly greater than a diameter of the duct.

7. The filter of claim 6, wherein the filter has a filter height that is approximately equal to a height of the pipe.

8. The filter of claim 1, wherein:
the filter surface defines a truncated cone.

9. The filter of claim 8, wherein the filter lower diameter is slightly greater than a diameter of the duct.

10. The filter of claim 8, wherein the truncated cone has a height greater than a diameter of the duct.

11. The filter of claim 8, wherein the truncated cone has a height of least 80% and not more than 120% of a height of the pipe.

12. The filter of claim 8, wherein the upper hole includes a notch configured to pass over a pipe bump.

13. The filter of claim 8, wherein the filter surface further includes a top flap configured to extend upwardly above the truncated cone and configured for attachment to the pipe.

14. The filter of claim 1, wherein:
the filter surface defines a truncated cone;
the filter surface comprises a mesh structure defining regularly spaced regular openings of less than ¼ inch diameter or width; and
the filter lower hole diameter is slightly greater than a diameter of the duct.

15. The filter of claim 1, wherein:
the filter surface defines a truncated cone;
the filter lower hole diameter is slightly greater than a diameter of the duct; and
the filter has a filter height of at least 50% and not more than 120% of a height of the pipe.

16. The filter of claim 1, wherein the filter is a truncated cone, and wherein the truncated cone is created from a flexible flat material having a shape of a truncated cone that has been slit and flattened.

17. The filter of claim 16, wherein the truncated cone is held in shape by at least two staples passing across the slit.

18. The filter of claim 16, wherein the slit and flattened truncated cone further includes an edge flap, and wherein the edge flap is positioned over an opposite edge of the flattened truncated cone to create a truncated cone.

19. A filter assembly for creating a filter to increase an efficiency of a blower, wherein the blower includes a pipe, a duct, and a base, the filter assembly comprising:
a flexible material in the shape of a slit and flattened truncated cone; and
regularly spaced openings of not more than ¼ inch located in the flexible material,
wherein the truncated cone includes:
a filter upper hole having an upper hole diameter and configured to accommodate a diameter of the pipe;
a filter surface with openings configured pass inlet air and to block undesired objects; and
a filter lower hole having a lower hole diameter, and
wherein the truncated cone lower hole diameter is slightly greater than a diameter of the duct, and
wherein the filter has a filter height of at least 50% and not more than 120% of a height of the pipe.

20. A blower comprising:
a pipe configured to transmit power;
a duct including a duct upper surface and a duct side surface; and
a base including a base upper surface, a base side surface, a base lower surface, and a base air outlet; and
wherein the base air outlet defines an air outlet area configured to pass an outlet air flow,
wherein the duct upper surface includes an open area configured to pass an inlet air flow, and wherein the open area is less than a cross sectional area of the duct, and
wherein the duct side surface includes supplemental openings configured to pass supplemental inlet air into the duct and configured to block leaves.
